(19) United States
(12) Patent Application Publication
(10) Pub. No.: US 2006/0216029 A1
(43) Pub. Date: Sep. 28, 2006

(54) Method and system for improving upstream efficiency in extended broadcasting networks

(75) Inventors: Olga I. Vassilieva, Plano, TX (US); Cechan Tian, Plano, TX (US); Susumu Kinoshita, Plano, TX (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 11/088,134

(22) Filed: Mar. 23, 2005

(51) Int. Cl. H04J 14/02

(52) U.S. Cl. 398/83

(57) ABSTRACT

An optical network includes at least one Level 1 network that includes a number of interconnection nodes and one or more Level 2 networks that each include one or more access nodes. The one or more Level 2 networks are each coupled to the Level 1 network via at least one interconnection node. One or more of the access nodes are each operable to add upstream traffic to the associated Level 2 network in a sub-wavelength, each sub-wavelength comprising a portion of a wavelength associated with the Level 1 network. Furthermore, one or more of the interconnection nodes are each operable to receive upstream traffic from a number of access nodes in a number of sub-wavelengths, process the upstream traffic in the sub-wavelengths as traffic in a single wavelength associated with the Level 1 network, and forward the upstream traffic from the access nodes in the single wavelength on the Level 1 network.

### TECHNICAL FIELD OF THE INVENTION

The present invention relates generally to optical transport systems and, more particularly, to a method and system for improving upstream efficiency in extended broadcasting networks.

### BACKGROUND

Telecommunications systems, cable television systems and data communication networks use optical networks to rapidly convey large amounts of information between remote points. In an optical network, information is conveyed in the form of optical signals through optical fibers. Optical fibers comprise thin strands of glass capable of transmitting the signals over long distances with very low loss.

Optical networks often employ wavelength division multiplexing (WDM) or dense wavelength division multiplexing (DWDM) to increase transmission capacity. In WDM and DWDM networks, a number of optical channels are carried in each fiber at disparate wavelengths. Network capacity is based on the number of wavelengths, or channels, in each fiber and the bandwidth, or size of the channels.

The topology in which WDM and DWDM networks are built plays a key role in determining the extent to which such networks are utilized. Ring topologies are common in today's networks. WDM add/drop units serve as network elements on the periphery of such optical rings. By using WDM add/drop equipment at network nodes, the entire composite signal can be fully demultiplexed into its constituent channels and switched (added/dropped or passed through).

Additionally, the use of add/drop units within such optical networks makes it possible to broadcast traffic to multiple destinations with a single transmission. Nonetheless, a fault or other disruptive event on the optical network may result in all network elements downstream from the disruption not receiving the broadcast traffic. The likelihood of a fault disrupting traffic only increases when broadcast transmissions are propagated over multiple, interconnected optical networks, as variations in component quality and operating parameters inject significant uncertainty into transmissions. Thus, while broadcast transmissions provide an effective technique for communicating information to many destinations concurrently, these transmission may be more vulnerable to disruption.

Furthermore, while a single wavelength or a small number of wavelengths may be used to broadcast the same information to many nodes in a network, each of these nodes, including nodes in interconnected networks, may need to send traffic upstream to a node that is the source of the broadcast traffic (or to other appropriate nodes). Traditionally, each node has required a separate wavelength on which to transmit this upstream traffic to avoid interference between the upstream traffic sent from the various nodes. However, such a configuration requires to use of a large number of wavelengths and results in the inefficient use of wavelength capacity.

### SUMMARY

In accordance with a particular embodiment of the present invention, an optical network includes at least one Level 1 network that includes a number of interconnection nodes and one or more Level 2 networks that each include one or more access nodes. The one or more Level 2 networks are each coupled to the Level 1 network via at least one interconnection node. One or more of the access nodes are each operable to add upstream traffic to the associated Level 2 network in a sub-wavelength, each sub-wavelength occupying a portion of a passband of a single wavelength associated with the Level 1 network. Furthermore, one or more of the interconnection nodes are each operable to receive upstream traffic from a number of access nodes in a number of sub-wavelengths, process the upstream traffic in the sub-wavelengths as traffic in a single wavelength associated with the Level 1 network, and forward the upstream traffic from the access nodes in the single wavelength on the Level 1 network.

In accordance with another embodiment of the present invention, an optical network includes at least one Level 1 network that includes a number of interconnection nodes and one or more Level 2 networks that each include one or more access nodes. The one or more Level 2 networks are each coupled to the Level 1 network via at least one interconnection node. One or more of the access nodes are each operable to add upstream traffic to the associated Level 2 network in a particular wavelength. Access nodes associated with the same Level 2 network use different wavelengths to add upstream traffic and access nodes associated with different Level 2 networks may use the same wavelength to add upstream traffic. Furthermore, one or more of the interconnection nodes are each operable to receive upstream traffic from a number of access nodes in a number of wavelengths, combine the received upstream traffic, and forward the upstream traffic on the Level 1 network in a wavelength different than the wavelengths in which the upstream traffic was received by the interconnection node.

Technical advantages of one or more embodiments of the present invention may include increased bandwidth and wavelength utilization efficiency. For example, particular embodiments take advantage of the fact that access nodes on a Level 2 network do not need high capacity to transmit upstream traffic. Thus, the passband of a high data rate wavelength can be shared between multiple access nodes by splitting the passband of the wavelength into several lower rate sub-wavelengths and assigning each sub-wavelength to an access node for transmission of upstream traffic. In addition, low-cost, low-rate transmitters may be used at the access nodes to transmit traffic in these sub-wavelengths. Furthermore, these sub-wavelengths can be easily grouped into a full wavelengths for transmission over a Level 1 network. The use of such wavelengths eliminates the need to assign a separate high rate wavelength to each access node for the transmission of upstream traffic, which wastes wavelength capacity. Moreover, the grouping of low rate sub-wavelengths into a full high rate wavelength significantly reduces the number of upstream wavelengths. Therefore, the wavelength utilization for upstream traffic is more efficient than in previously used techniques.

Other embodiments of the present invention may reduce the total number of wavelengths allocated to upstream transmissions in a network by re-using particular wavelengths in different Level 2 networks for transmission of upstream traffic by particular access nodes in these different Level 2 networks. Such embodiments may convert the wavelength of this upstream traffic before adding the traffic to the Level 1 network, so as to prevent collision and interference of different traffic in the same wavelength. Furthermore, upstream traffic received from multiple access nodes in a Level 2 network may be converted into a single wavelength to reduce the number of wavelengths used to transmit upstream traffic in the Level 1 network.

It will be understood that the various embodiments of the present invention may include some, all, or none of the enumerated technical advantages. In addition, other technical advantages of the present invention may be readily apparent to one skilled in the art from the figures, description and claims included herein.

### BRIEF DESCRIPTION OF THE DRAWINGS

FIG. 1 is a block diagram illustrating an example optical network;

FIG. 2 is a block diagram illustrating an example of the propagation of broadcast traffic in the optical network of FIG. 1;

FIG. 3 is a block diagram illustrating a technique for communicating upstream traffic in the network of FIG. 1;

FIG. 4A is a block diagram illustrating an improved technique for communicating upstream traffic in the network of FIG. 1 according to a particular embodiment of the present invention;

FIGS. 4B and 4C are diagrams illustrating example wavelengths and sub-wavelengths used to transmit traffic in the network of FIG. 4A;

FIG. 5 is a block diagram illustrating another improved technique for communicating upstream traffic in the network of FIG. 1 according to a particular embodiment of the present invention;

FIGS. 6A-6C are block diagrams illustrating example access nodes that may be used in association with particular embodiments of the present invention; and

FIGS. 7A and 7B are block diagrams illustrating example interconnection nodes that may be used in association with particular embodiments of the present invention.

### DETAILED DESCRIPTION

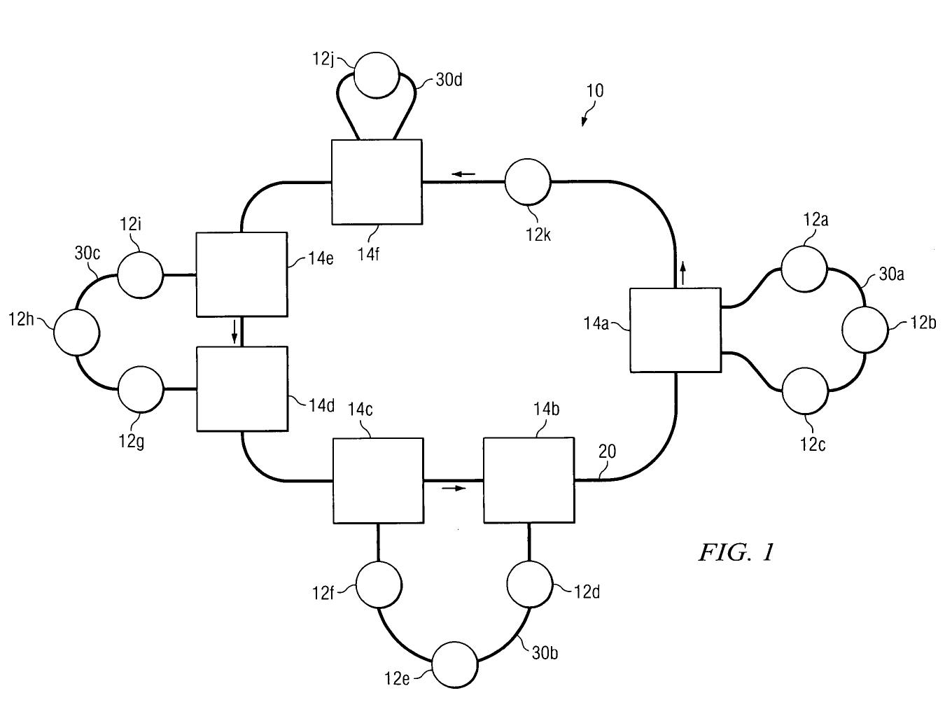

FIG. 1 illustrates an example optical network 10. The example network 10 includes a Level 1 network 20 and a plurality of Level 2 networks 30 coupled to the Level 1 network 20. In a particular embodiment, the Level 2 networks 30 may represent subtended networks of the Level 1 network 20. Network 10 includes one or more interconnection nodes 14 that are capable of coupling one or more Level 2 networks 30 to the Level 1 network 20 or to other Level 2 networks 30. Network 10 also includes a plurality of access nodes 12 located throughout network 10 that each facilitate communication of traffic to and from one or more client devices coupled to the access nodes. Interconnection nodes 14 may also support this functionality. As described below, interconnection nodes 14 enable extended broadcasting of selected traffic from the Level 1 network 20 to the Level 2 networks 30. Such broadcasting of traffic is often important in networks, particularly networks that support applications such as cable television, high definition television, video on demand, and grid computing. Furthermore, these interconnection nodes 14 allow access nodes 12 to transmit upstream traffic on the Level 1 network 20 (for example, to request particular programming or video).

Network 10 is an optical network in which a number of optical channels are carried over a common path in disparate wavelengths/channels. Network 10 may be a wavelength division multiplexing (WDM), dense wavelength division multiplexing (DWDM), or other suitable multi-channel network. Traffic may be transmitted as optical signals on the Level 1 network 20 and the Level 2 networks 30. As used herein, “traffic” may include any information transmitted, stored, or sorted in the network. This optical traffic may have at least one characteristic modulated to encode audio, video, textual, real-time, non-real-time and/or other suitable data. Additionally, traffic transmitted in optical network 10 may be structured in any appropriate manner including, but not limited to, being structures as frames, packets, or an unstructured bit stream.

The Level 1 network 20 and the Level 2 networks 30 include one or more fibers capable of transporting optical signals transmitted by components of network 10. The Level 1 networks 20 and the Level 2 networks 30 may each include, as appropriate, a single, unidirectional fiber; a single, bi-directional fiber; or a plurality of uni- or bi-directional fibers. In the illustrated embodiment, both the Level 1 network 20 and the Level 2 networks 30 include a single unidirectional fiber configured to transport traffic in a predetermined direction. Although this description focuses, for the sake of simplicity, on an embodiment of network 10 that supports unidirectional traffic, the present invention further contemplates a bi-directional system that includes appropriately modified embodiments of the components described below to support the transmission of traffic in opposite directions around rings 20 and 30. For example, the Level 1 network 20 and the Level 2 networks 30 may each comprise multiple fibers, including one or more fibers supporting transmission of traffic in a clockwise direction and one or more fibers supporting transmission of traffic in a counterclockwise direction (for example, to allow protection switching). Furthermore, networks 20 and 30 may have any suitable network topology.

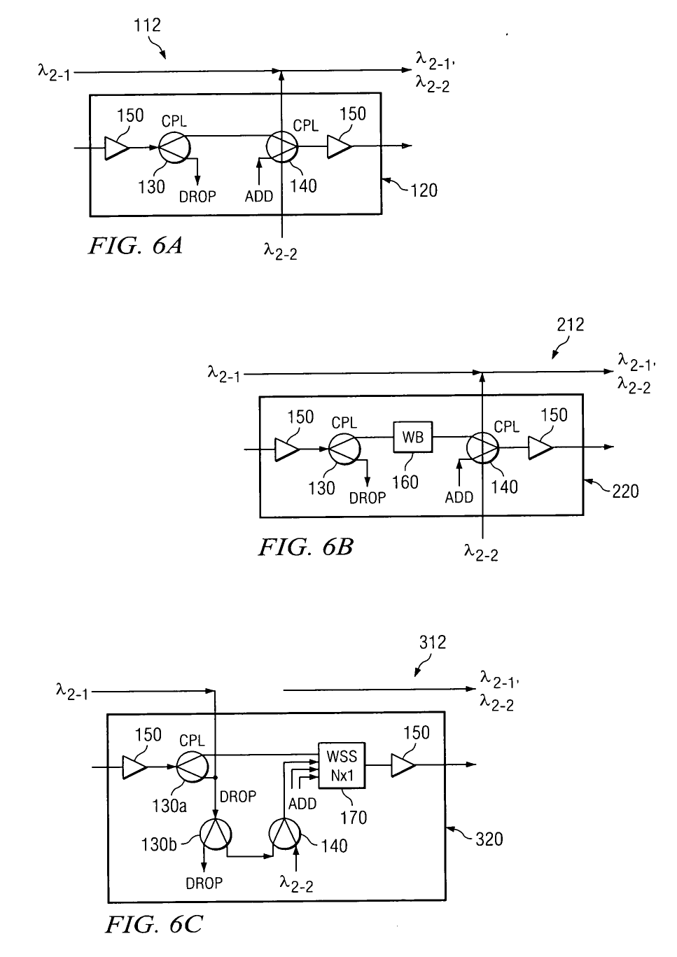

Access nodes 12 are each operable to add and drop traffic to and from the Level 2 networks 30 (and from the Level 1 network 20, if appropriate). In particular, each access node 12 receives traffic from local clients and adds that traffic to the Level 1 network 20 or a particular Level 2 network 30. At the same time, each access node 12 receives traffic from the Level 1 network 20 or Level 2 networks 30 and drops traffic destined for the local clients. For the purposes of this description, access nodes 12 may “drop” traffic by transmitting a copy of the traffic to any appropriate components coupled to the access nodes 12. As a result, each access node 12 may drop traffic from the Level 1 network 20 or a Level 2 network 30 by transmitting the traffic to components coupled to that access node 12 while allowing the traffic to continue to downstream components on the Level 1 network 20 or a Level 2 network 30. As used throughout this description and the following claims, the term “each” means every one of at least a subset of the identified items. The contents of particular embodiments of access nodes 12 are described in greater detail below with respect to FIGS. 6A-6C.

Interconnection nodes 14 facilitate the routing of appropriate traffic between the Level 1 network 20 and the Level 2 networks 30. In particular, interconnection nodes 14 are operable to forward certain traffic to the Level 2 networks 30 from the Level 1 network 20 and to add certain traffic from the Level 2 networks 30 to the Level 1 network 20. Interconnection nodes 14 may forward all traffic from the Level 1 network 20 to the Level 2 networks 30 or may be configured to pass only certain traffic through to the Level 2 networks 30 based on the wavelength, the destination, or any other appropriate characteristics of the selected traffic. Similarly, an interconnection node 14 may add all traffic received from an associated Level 2 network 30 to the Level 1 network 20 or it may be configured to only pass certain traffic though to the Level 1 network 20 based on the wavelength, the destination, or any other appropriate characteristics of the selected traffic. For example, in a particular embodiment, certain traffic is designated as broadcast traffic and particular interconnection nodes 14 forward such broadcast traffic to the Level 2 networks 30 while particular interconnection nodes 14 terminate broadcast traffic as this traffic exits each Level 2 network 30.

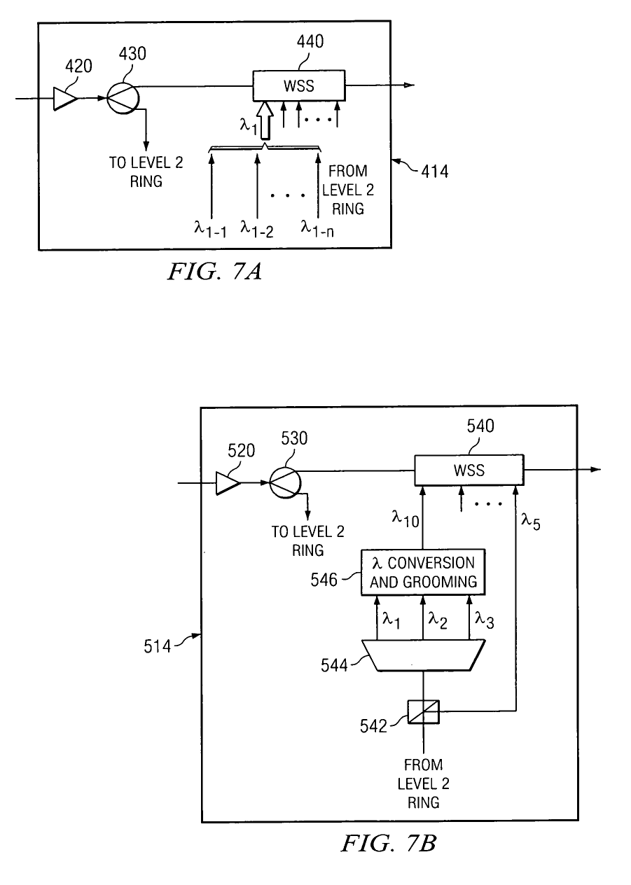

Depending on the configuration of a particular Level 2 network 30, a first interconnection node 14 may be configured to forward traffic from the Level 1 network 20 to that Level 2 network 30, while a different interconnection node 14 may be configured to add traffic from that Level 2 network 30 to the Level 1 network 20. For example, interconnection node 14e of FIG. 1 is configured to forward appropriate traffic to Level 2 network 30c, while interconnection node 14d is configured to add appropriate traffic from Level 2 network 30c to the Level 1 network 20. For other Level 2 networks 30, a single interconnection node 14 may both forward traffic to that Level 2 network 30 and also add traffic from that Level 2 network 30 to the Level 1 network 20. For example, interconnection node 14a of FIG. 1 both forwards traffic from the Level 1 network 20 to the Level 2 network 30a and adds traffic from the Level 2 network 30a to the Level 1 network 20. FIGS. 7A and 7B illustrate the contents of particular embodiments of interconnection nodes 14 in greater detail.

Furthermore, although not illustrated in FIGS. 7A or 7B, in addition to adding and forwarding traffic to and from Level 2 networks 30, interconnection nodes 14 may be configured to add and drop traffic for local clients coupled to interconnection nodes 14, in a similar manner as access nodes 12. Interconnection nodes 14 may combine traffic from local clients for transmittal on the Level 1 network 20 and may drop traffic from the Level 1 network 20 to local clients.

In operation, the Level 1 network 20 and the Level 2 networks 30 transport traffic transmitted by client devices and other components on network 10. As traffic on the Level 1 network 20 traverses a interconnection node 14, the interconnection node 14 may forward the traffic to an associated Level 2 network 30 coupled to that interconnection node 14. As described above, the interconnection node 14 may forward all traffic on the Level 1 network 20 to the coupled Level 2 network 30 or a subset of that traffic (for example, traffic which is designated as “broadcast” traffic) intended for transmission to the associated Level 2 network 30. In particular, an interconnection node 14 splits traffic designated for transmission to the associated Level 2 network 30 into two copies. The interconnection node 14 forwards one copy of the traffic to the next downstream component on the Level 1 network 20 and forwards the other copy to the next downstream component on the one or more Level 2 networks 30 coupled to the interconnection node 14. This may be referred to as “drop and continue” or “broadcast and select.”

Due to this use of “drop and continue” or “broadcast and select” when transmitting traffic to the Level 2 networks 30, greater operational reliability in network 10 is attained. In particular, because interconnection nodes 14 forward received traffic to both the Level 1 network 20 and the associated Level 2 network(s) 30, breaks or other faults in a particular Level 2 network 30 may not disrupt the transmission of this traffic on the Level 1 network 20 and/or to other Level 2 networks 30. Consequently, particular embodiments of network 10 may provide for more reliable communication of information across network 10, particularly where the information is being broadcast to multiple Level 2 networks 30. Furthermore, because traffic arriving at a interconnection node 14 associated with a particular Level 2 network 30 does not need to traverse that Level 2 network 30 before advancing to the next interconnection node 14 or other downstream component, particular embodiments of network 10 may be able to communicate information throughout a particular network 10 more quickly. Moreover, as is described in further detail below, network 10 also supports the transmission of traffic upstream from access nodes 12 to facilitate the needs of those nodes.

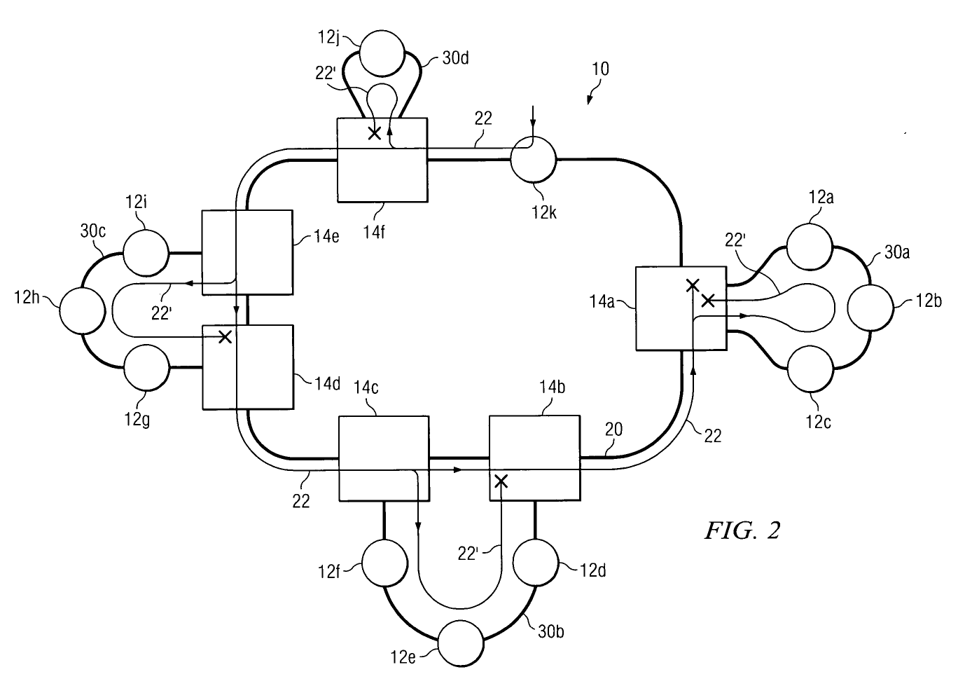

FIG. 2 illustrates the transmission of an example broadcast traffic stream 22 throughout network 10. As noted above, broadcast traffic stream 22 may represent some or all of the traffic transmitted on the Level 1 network 20. As shown in FIG. 2, upon receiving broadcast traffic stream 22, particular interconnection nodes 14 forward broadcast traffic stream 22 to one end of an associated Level 2 network 30 and the same interconnection node 14 or another interconnection node 14 will terminate broadcast traffic stream 22 once broadcast traffic stream 22 reaches the opposite end of that particular Level 2 network 30. By terminating broadcast traffic stream 22 at the other end of the Level 2 network 30, the relevant interconnection node 14 may prevent interference with broadcast traffic stream 22 propagating on Level 1 network 20. As described in further detail below, interconnection nodes 14 may also receive upstream traffic originating from access nodes 12 on the associated Level 2 network 30 and may add this upstream traffic to the traffic already propagating on Level 1 network 20 to allow this traffic to be transmitted elsewhere on Level 1 network 20 or to other Level 2 networks 30.

As shown in FIG. 2, an example broadcast traffic stream 22 is transmitted on Level 1 network 20 from access node 12k. Alternatively, broadcast traffic may originate at any other node 12 or 14 coupled to the Level 1 network 20 or to a Level 2 network 30. For example, if broadcast traffic stream 22 is added to the Level 1 network 20 from an interconnection node 14, such traffic may have originated from another network or any appropriate component coupled to the interconnection node 14. After being transmitted, broadcast traffic stream 22 propagates around Level 1 network 20 as shown. When broadcast traffic stream 22 reaches a interconnection node 14, that interconnection node 14 splits broadcast traffic stream 22 to form two copies of broadcast traffic stream 22. The interconnection node 14 then forwards one copy (broadcast traffic stream 22) to the next downstream component on the Level 1 network 20 and forwards the other copy (broadcast traffic stream 22′) to the Level 2 network 30 coupled to interconnection node 14. Once broadcast traffic stream 22′ has propagated over the length of the relevant Level 2 network 30, the interconnection node 14 at the opposite end of that Level 2 network 30 (which may be the same node 14 that forwarded the broadcast traffic 22′ to the network 30 or may be a different node 14) terminates broadcast traffic stream 22′. In this manner, broadcast traffic 22 is broadcast to all nodes 12 and 14 coupled to network 10. Further details of the operation of a network to broadcast traffic are described in co-pending U.S. patent application Ser. No. 10/996,707, entitled “Optical Ring Network For Extended Broadcasting,” which is incorporated herein by reference.

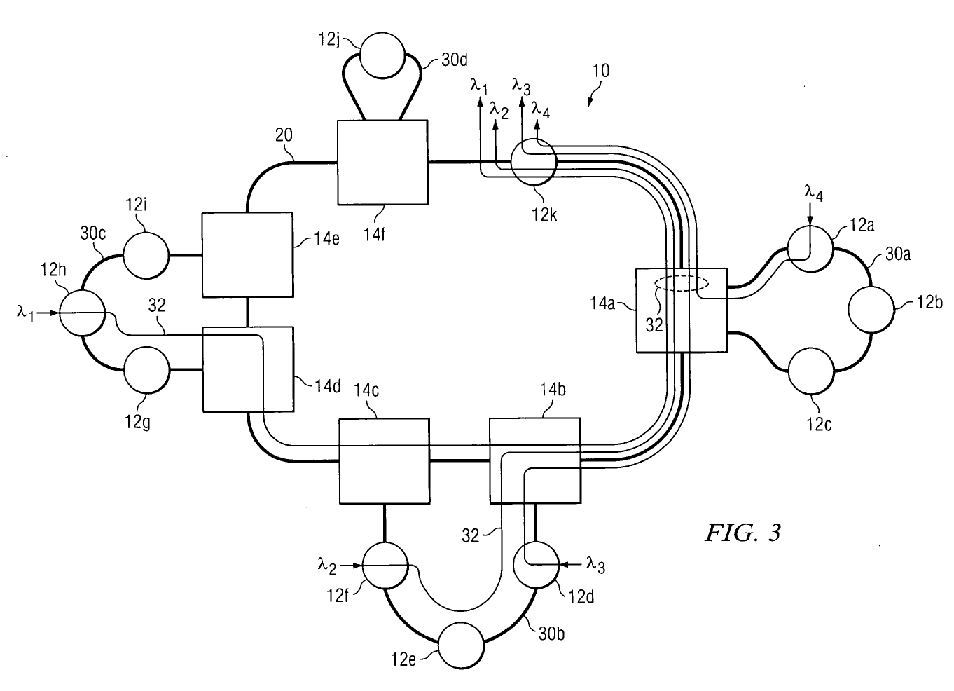

FIG. 3 is a block diagram illustrating an example technique for communicating upstream traffic in the network of FIG. 1. As mentioned above, in addition to receiving broadcast traffic, access nodes 12 may often need to communicate upstream traffic to other nodes 12 or 14 in network 10. For example, for a cable television application, access nodes 12 may need to send requests for programming to a node 12 or 14 in network 10 from which programming is sent (i.e., as broadcast traffic). In typical existing networks, each access node 12 in the Level 2 networks 30 is allocated a unique wavelength on which to transmit its upstream traffic. For example, in FIG. 3, access node 12h is assigned λ₁, access node 12f is assigned λ₂, access node 12d is assigned λ₃, and access node 12a is assigned λ₄. Although each access node 12 may be assigned a wavelength, only four example wavelength assignments are illustrated in FIG. 3 for the sake of simplicity.

In the illustrated example, each of these access nodes 12 transmits a different upstream traffic stream 32 (for example, that is received from client devices coupled to that access node 12) on its associated Level 2 network 30. Unlike broadcast traffic stream 22 of FIG. 2, each traffic stream 32 is not terminated when it reaches the interconnection node 14 coupled to the terminal end of the associated Level 2 network. Instead, the relevant interconnection node 14 adds the local traffic stream 32 to other traffic propagating on Level 1 network 20 (for example the traffic streams 32 from other access nodes 12 and one or more broadcast streams 22). Although the example upstream traffic 32 from these nodes is shown as being communicated to access node 12k of the Level 1 network 20, this traffic may be communicated to any suitable node 12 or 14 on the Level 1 network 20 or a Level 2 network 30.

As can be seen, through the assignment of unique wavelengths to each access node 12, the traffic from an access node 12 that is added to the Level 1 network 20 by an associated interconnection node 14 does not interfere with any other traffic communicated from other access nodes 12. However, allocating a unique wavelength to each access node 12 may require the use of a large number wavelengths—in the example network 10, this would require ten separate wavelengths. Furthermore, this upstream traffic is typically light. Therefore, even though each access node 12 has its own wavelength, little of the capacity of each of these wavelengths is used. This results in a low wavelength utilization efficiency. Furthermore, this often requires that the destination node 12 or 14 have a receiver for each of these wavelengths, resulting in high equipment costs. Particular embodiments of the present invention, for example as illustrated and described in conjunction with the following figures, address these issues of low wavelength utilization efficiency and high equipment costs.

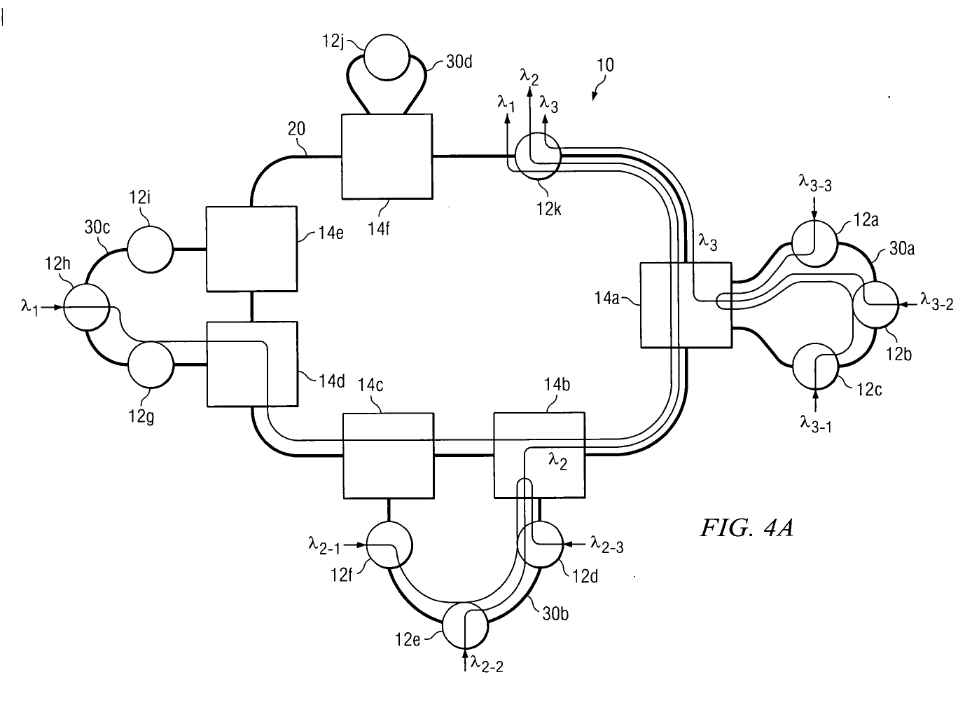

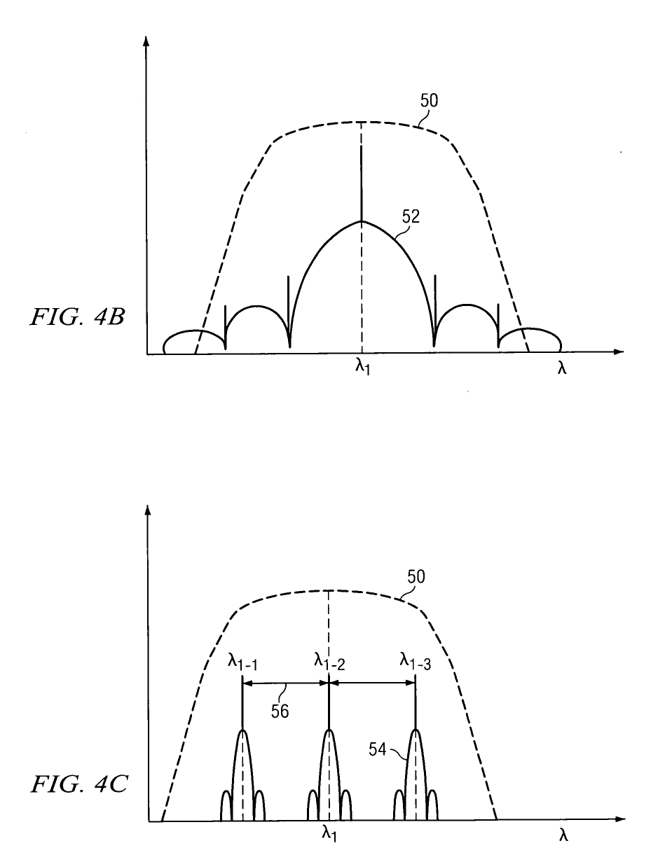

FIG. 4A is a block diagram illustrating an improved technique for communicating upstream traffic in the network of FIG. 1 according to a particular embodiment of the present invention. In this improved technique, for transmission of upstream traffic, two or more access nodes 12 in a particular Level 2 network 30 share the same amount of wavelength spectrum used by a single wavelength for transmitting broadcast or other downstream traffic on the Level 1 network 20. This sharing or segmenting of the spectrum of a single high rate wavelength is accomplished by defining multiple lower rate “sub-wavelengths” within the spectrum typically occupied by a single downstream wavelength and assigning each of these sub-wavelengths to a different access node 12 for use in transmitting upstream traffic in its Level 2 network 30. The traffic in these sub-wavelengths can then be grouped by the interconnection node 14 coupling the Level 2 network 30 to the Level 1 network 20 and the combined traffic can be communicated over the Level 1 network 20. Thus, the traffic from multiple access nodes 12 may be communicated over the Level 1 network 20 in same amount of spectrum that is reserved for downstream traffic from a single node (which is also the same amount of spectrum that is reserved for upstream traffic from a single node in FIG. 3).

More specifically, sub-wavelengths may be used in a Level 2 network 30 when the access nodes 12 in that network 30 require only a portion of the capacity of the high rate wavelength for transmitting upstream traffic (which is typically the case). Sub-wavelengths may be defined within the spectrum of a higher rate wavelength as each comprising a portion (sub-band) of the wavelength spectrum associated with that higher rate wavelength. FIG. 4B is a diagram illustrating an example high rate wavelength, λ₁, having a spectrum 52 and FIG. 4C is a diagram illustrating example sub-wavelengths, λ₁₋₁, λ₁₋₂, and λ₁₋₃, having spectrums 54 defined within the spectrum 52 used by λ₁. The sub-wavelengths are separated by a narrow channel spacing 56. As is illustrated in FIGS. 4B and 4C, all of spectrums 54 occupy the same passband 50 of a WSS (which is described below in conjunction with FIG. 7A) as spectrum 52, and thus a WSS will see sub-wavelengths λ₁₋₁, λ₁₋₂, and λ₁₋₃ as a single wavelength, λ₁. As is illustrated, λ₁ is the center wavelength of the WSS passband 50 (and is also the center wavelength of the optical spectrum to avoid spectrum distortion). In particular embodiments, λ₁ may have a 40 Gb/s NRZ spectrum and each of sub-wavelengths λ₁₋₁, λ₁₋₂, and λ₁₋₃ may have a lower rate 1 Gb/s NRZ spectrum. The bandwidth of spectrums 52 and 54 is proportional to the data rate. Thus, in this example, spectrums 54 are forty times narrower than spectrum 52 and have one-fortieth of its traffic-carrying capacity. However, as mentioned above, this lower rate is typically sufficient for transmitting upstream traffic from access nodes 12.

Referring again to FIG. 4A, sub-wavelengths are identified using the notation λ_{x,y}, where x is the higher rate wavelength whose passband is occupied by the sub-wavelengths and y identifies a particular wavelength in a Level 2 network 30. For example, λ₂ is subdivided into sub-wavelengths λ₂₋₁, λ₂₋₂, and λ₂₋₃ and λ₃ is subdivided into sub-wavelengths λ₃₋₁, λ₃₋₂, and λ₃₋₃. Although all the access nodes 12 in each of Level 2 networks 30a and 30b are illustrated as using sub-wavelengths defined in the passband of a single higher rate wavelength, multiple higher rate wavelength passbands may be sub-divided into sub-wavelengths for use by access nodes 12 in a single Level 2 network 30. For example, if up to eight low rate sub-wavelengths can be allocated in a single WSS passband but a particular Level 2 network 30 includes more than eight access nodes 12, sub-wavelengths may be allocated to the access nodes 12 in two or more different WSS passbands. For instance, if a Level 2 network 30 includes ten access nodes 12, the access nodes 12 might be assigned the following sub-wavelengths: λ₁₋₁, λ₁₋₂, λ₁₋₃, λ₁₋₄, λ₁₋₅, ο₁₋₆, λ₁₋₇, λ₁₋₈, λ₂₋₁, λ₂₋₂. Furthermore, particular access nodes 12 may use an entire wavelength for upstream transmission (such as access node 12h in FIG. 4A) while other access nodes 12 use sub-wavelengths for upstream transmissions.

In operation, using Level 2 network 30a as an example, each access node 12a, 12b and 12c transmits upstream traffic as needed on its assigned sub-wavelength, λ₃₋₃, λ₃₋₂, and λ₃₋₁, respectively. This traffic travels around network 30a in these separate sub-wavelengths until the traffic reaches interconnection node 14a. Interconnection node 14a includes one or more components that receive the traffic in these separate sub-wavelengths and groups the traffic in these sub-wavelengths as a single wavelength for transmission on the Level 1 network 20. For example, λ₃₋₁, λ₃₋₂, and λ₃₋₃ are grouped as traffic λ₃ for transmission of the upstream traffic from access nodes 12a, 12b, and 12c on the Level 1 network 20. As an example only, and as is described in more detail below in conjunction with FIG. 7A, these components may include a wavelength selective switch (WSS) that recognizes and passes through the sub-wavelengths as a single wavelength, λ₃. Thus, all the sub-wavelengths of λ₃ are controlled by WSS together as a single wavelength.

The traffic in the grouped sub-wavelengths of λ₃ are then communicated from interconnection node 14a on Level 1 network 20. In the example of FIG. 4A, this traffic is communicated to the destination on Level 1 network 20—node 12k (the destination on the Level 1 network 20 could also be an interconnection node 14). The destination node includes one or more components that are operable to receive the traffic in the grouped sub-wavelengths of λ₃ and retrieve the traffic in each of the sub-wavelengths. For example, the destination node may use narrow band optical filters and associated receivers to retrieve the traffic in these sub-wavelengths. In this manner, the technique illustrated and described in conjunction with FIG. 4A takes advantage of the fact that access nodes 12 do not need the full capacity of a high rate wavelength to transmit upstream traffic. Thus, the capacity of a higher rate wavelength can be shared between multiple access nodes 12 using the sub-wavelength concept. Furthermore, these sub-wavelengths can be easily grouped for transmission over the Level 1 network 20. The use of such sub-wavelengths eliminates the need to assign a separate high rate wavelength to each access node 12 for the transmission of upstream traffic (which, as described above, wastes wavelength capacity and requires the use of large number of wavelengths). Instead, each access node 12 is assigned a sub-wavelength that occupies only a portion of the passband and data rate of a higher rate wavelength (such as used to communicate downstream traffic or to communicate upstream traffic in FIG. 3). Therefore, the total number of wavelengths allocated to upstream transmissions on Level 1 network 20 is reduced, as compared to previous techniques. Therefore, this technique is more efficient and cost-effective than previous techniques.

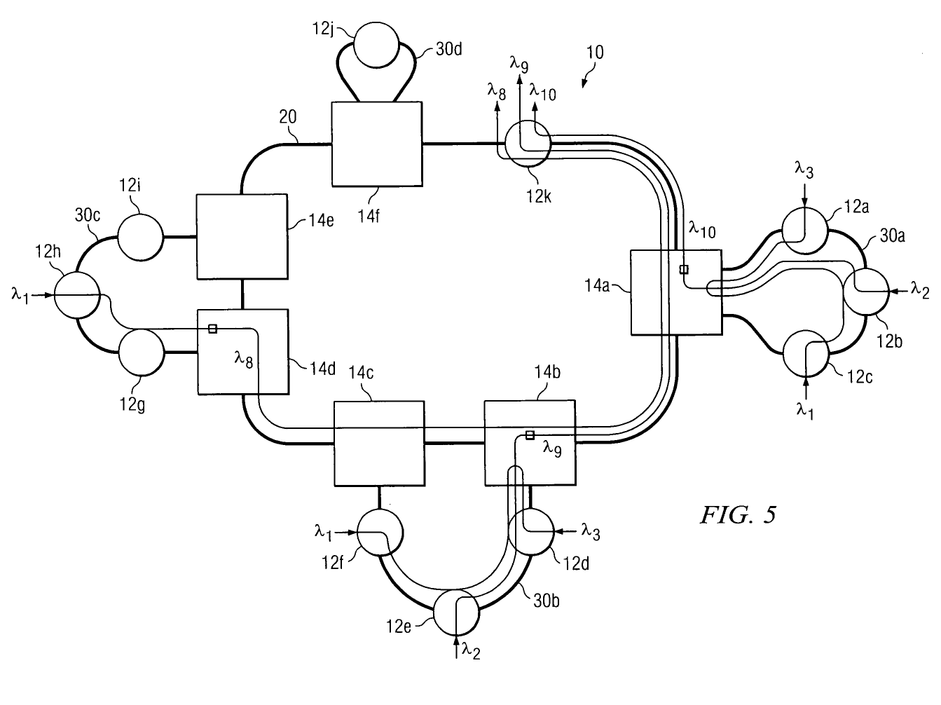

FIG. 5 is a block diagram illustrating another improved technique for communicating upstream traffic in the network of FIG. 1 according to a particular embodiment of the present invention. Unlike in the technique of FIG. 4A, this technique does not use sub-wavelengths. However, this technique does reduce (as compared to the technique of FIG. 3) the total number of wavelengths allocated to upstream transmissions in network 10 and reduces the total number of wavelengths used to transmit upstream traffic on Level 1 network 20. This is accomplished by re-using wavelengths for transmission of upstream traffic in different Level 2 networks 30 and by combining the traffic in these re-used wavelengths from each Level 2 network 30 and transmitting this combined traffic from each Level 2 network 30 on the Level 1 network 20 in a unique wavelength(s).

For example, referring to FIG. 5, λ₁ is used to transmit upstream traffic from each of access nodes 12c, 12f, and 12h to their respective interconnection nodes 14a, 14b, and 14d. Similarly, λ₂ and λ₃ are used by access nodes 12 in both Level 2 networks 30a and 30b. Thus, λ₁, λ₂ and λ₃ are able to be “re-used” to transmit upstream traffic in multiple Level 2 networks 30. Furthermore, to reduce the number of wavelengths used to transmit upstream traffic in Level 1 network 20, the traffic from multiple access nodes 12 on a particular Level 2 network may be combined into a single wavelength for transmission on the Level 1 network 20 (or multiple wavelengths may be used if needed). To prevent interference in the network, the wavelength used to transmit this combined traffic from a particular Level 2 network 30 is different than the wavelengths used to transmit combined traffic from other Level 2 networks 30 and different than the re-used wavelengths used by access nodes 12 to transmit upstream traffic in the Level 2 networks 30.

In operation, each access node 12a, 12b and 12c of Level 2 network 30a transmits upstream traffic as needed on its assigned wavelength, λ₁, λ₂, and λ₃, respectively. This traffic travels around network 30a in these separate wavelengths until the traffic reaches interconnection node 14a. Interconnection node 14a includes one or more components that receive the traffic in these separate wavelengths, combine the traffic, and transmit the combined traffic in a different wavelength (in this example, λ₁₀). For example, as described in more detail in conjunction with FIG. 7B, these components may convert the received optical traffic received from nodes 12a, 12b and 12c into electrical traffic, combine this electrical traffic, and then convert this combined electrical traffic into optical traffic transmitted at λ₁₀. This traffic in λ₁₀ is then communicated from interconnection node 14a on Level 1 network 20. In the example of FIG. 5, this traffic is communicated to the destination on the Level 1 network 20—node 12k (the destination on the Level 1 network 20 could also be an interconnection node 14).

Similarly, each access node 12d, 12e and 12f of Level 2 network 30b transmits upstream traffic as needed on its assigned wavelength, λ₁, λ₂, and λ₃, respectively. Thus, all three of these wavelengths are re-used (shared) by multiple Level 2 networks 30. This traffic travels around network 30b in these separate wavelengths until the traffic reaches interconnection node 14b. Interconnection node 14b includes one or more components that receive the traffic in these separate wavelengths, combine the traffic, and transmit the combined traffic in a different wavelength (in this example, λ₉). This traffic in λ₉ is then communicated from interconnection node 14b on Level 1 network 20 to its destination. Access node 12h similarly uses λ₁ to transmit upstream traffic as needed in Level 2 network 30c. As with the other Level 2 networks 30, this traffic is received by the associated interconnection node (in this case, node 14d), is converted to another wavelength (in this case, λ₈), and is transmitted over the Level 1 network 20 to its destination. As can be seen from FIG. 5, traffic from any suitable number of access nodes 20 may be transmitted in this manner. Therefore, the total number of wavelengths allocated to upstream transmissions in network 10 and the total number of wavelengths used to transmit upstream traffic on Level 1 network 20 is reduced, as compared to previous techniques (such as the technique illustrated in FIG. 3). Therefore, this technique is more efficient and cost-effective than these previous techniques.

FIGS. 6A-6C are block diagrams illustrating particular embodiments of access nodes that may be used in association with particular embodiments of the present invention. It should be noted that although the illustrated nodes are illustrated to show their operation in conjunction with the technique discussed above with reference to FIG. 4A, these nodes may also be used in conjunction with the technique discussed above with reference to FIG. 5. Furthermore, any other suitable node configurations may alternatively be used.

FIG. 6A is a block diagram illustrating a portion of an example access node 112 in accordance with one embodiment of the present invention. The illustrated portion of the node is the transport element 120 that adds traffic to an associated Level 2 network 30 (or to the Level 1 network 20, if the node 112 is coupled to that network) and drops traffic from the Level 2 network 30 to facilitate the exchange of information between client devices of access node 112 and the Level 2 network 30. Although access node 112 as illustrated includes only a single transport element 120, particular embodiments of access node 112 may be configured to receive and transmit traffic on the associated Level 2 network 30 in more than one direction and may include additional transport elements 120 to facilitate such operation. For example, in a particular embodiment of network 10, traffic may propagate around Level 2 networks 30 in two directions with traffic on a first fiber traveling in a clockwise direction and traffic on a second fiber traveling in a counterclockwise direction. In such an embodiment, access node 112 may include two transport elements 120, one coupled to the first fiber for receiving and transmitting clockwise traffic and one coupled to the second fiber for receiving and transmitting counterclockwise traffic.

In the illustrated embodiment, transport element 120 includes a drop coupler 130, an add coupler 140, and amplifiers 150. Drop coupler 130 splits input traffic received on the fiber associated with transport element 120 into two copies. Each copy of the input traffic includes substantially the same content, but the power levels of each copy may differ. One copy of the input traffic is forwarded along the fiber to add coupler 140, while the other copy is dropped to appropriate components configured to deliver some or all of the traffic included in the drop copy to one or more clients of access node 112. For example, the dropped copy may be forwarded to a WSS, a demultiplexer, or any other component(s) that isolate the traffic in one or more wavelengths of the dropped copy. These isolated wavelengths may then be forwarded to one or more optical receivers, so that the optical traffic can be converted to electrical traffic for transmission to appropriate client devices. As an example of the operation of drop coupler 130, if the input traffic includes upstream traffic in sub-wavelength λ₂₋₁ from another node in the same Level 2 network 30 (as illustrated in FIG. 6A), drop coupler 130 drops a first copy of this traffic and forwards a second copy of this traffic. Assuming that the input traffic is not destined for access node 112 (such as in the example illustrated in FIG. 4A), the dropped copy will be terminated by the one or more components receiving the dropped copy. On the other hand, if the input traffic includes traffic that is destined for node 112 (for example, traffic in a wavelength that is being broadcast as described in FIG. 2), then these components would pass this particular traffic through to appropriate clients of node 112.

Add coupler 140 receives the forwarded copy of the input traffic from drop coupler 130 and also receives add traffic to be added to network 10 that originates from client devices. For example, as illustrated in FIG. 6A, this add traffic may be upstream traffic to be added in sub-wavelength λ₂₋₂ as described in FIG. 4A. The add traffic may be received from one or more components that receive electrical traffic from one or more client devices, convert that electrical traffic into optical traffic in one or more wavelengths, and multiplex the optical add traffic (if it is in multiple wavelengths). Add coupler 140 combines this received add traffic with the forwarded copy of the input traffic to create output traffic to be communicated on the network 30 with which node 112 is associated. Node 112 also includes, in the illustrated embodiment, amplifiers 150 which amplify the input traffic before it is split by drop coupler 130 and which amplify the output traffic before it communicated from node 112.

Although two couplers 130 and 140 are illustrated in transport element 120, particular embodiments may include a single coupler that both adds and drops traffic. Furthermore, although the illustrated embodiment is described as utilizing couplers, any other suitable optical splitters may be used. For the purposes of this description and the following claims, the terms “coupler,” “splitter,” and “combiner” should each be understood to include any device which receives one or more input optical signals, and either splits or combines the input optical signal(s) into one or more output optical signals.

FIG. 6B is a block diagram illustrating a portion of another example access node 212 in accordance with one embodiment of the present invention. The illustrated portion of the node is the transport element 220 that adds traffic to an associated Level 2 network 30 (or to the Level 1 network 20, if the node 212 is coupled to that network) and drops traffic from the Level 2 network 30 to facilitate the exchange of information between client devices of access node 212 and the Level 2 network 30. As with access node 112, although access node 212 as illustrated includes only a single transport element 220, particular embodiments of access node 212 may be configured to receive and transmit traffic on the associated Level 2 network 30 in more than one direction and may include additional transport elements 220 to facilitate such operation.

As with access node 112, access node 212 includes a drop coupler 130, an add coupler 140, and amplifiers 150. The operation of these components is the same as described above and thus will not be described again. In addition to these components, access node 212 also includes a wavelength blocker 160. Wavelength blocker is operable to block the traffic in one or more selected wavelengths of the copy of the input traffic forwarded from drop coupler 130. This wavelength blocker may be used in certain circumstances to prevent the propagation of particular wavelengths around the Level 2 network 30 (or Level 1 network 20) with which node 212 is associated. In the illustrated embodiment, the wavelength blocker is operable to pass through the traffic in sub-wavelength λ₂₋₁. Add coupler 140 receives the traffic forwarded by wavelength blocker and also receives add traffic to be added to network 10 in sub-wavelength λ₂₋₂. Add coupler 140 combines this received add traffic with the forwarded copy of the input traffic to create output traffic to be communicated on the network 30 with which node 212 is associated.

FIG. 6C is a block diagram illustrating a portion of yet another example access node 312 in accordance with one embodiment of the present invention. Again, the illustrated portion of the node is the transport element 320 that adds traffic to an associated Level 2 network 30 (or to the Level 1 network 20, if the node 312 is coupled to that network) and drops traffic from the Level 2 network 30 to facilitate the exchange of information between client devices of access node 312 and the Level 2 network 30. As with access nodes 112 and 212, although access node 312 as illustrated includes only a single transport element 320, particular embodiments of access node 312 may be configured to receive and transmit traffic on the associated Level 2 network 30 in more than one direction and may include additional transport elements 320 to facilitate such operation.

In the illustrated embodiment, transport element 320 includes a first drop coupler 130a, a second drop coupler 130b, an add coupler 140, amplifiers 150, and a WSS 170. The first drop coupler 130a splits input traffic received on the fiber associated with transport element 320 into two copies. Each copy of the input traffic includes substantially the same content, but the power levels of each copy may differ. One copy of the input traffic is forwarded along the fiber to WSS 170, while the other copy is dropped to the second drop coupler 130b. The second drop coupler 130b splits the dropped copy into two more copies. One of these copies is forwarded to add coupler 140, while the other copy is forwarded to appropriate components configured to deliver some or all of the traffic included in the drop copy to one or more clients of access node 312. For example, the dropped copy may be forwarded to a WSS, a demultiplexer, or any other component(s) that isolate the traffic in one or more wavelengths of the dropped copy. These isolated wavelengths may then be forwarded to one or more optical receivers, so that the optical traffic can be converted to electrical traffic for transmission to appropriate client devices.

Add coupler 140 receives the copy of the input traffic from drop coupler 130b and also receives add traffic to be added to network 10 that originates from client devices. For example, as illustrated in FIG. 6C, this add traffic may be upstream traffic to be added in sub-wavelength λ₂₋₂ as described in FIG. 4A. The add traffic may be received from one or more components that receive electrical traffic from one or more client devices, convert that electrical traffic to optical traffic in one or more wavelengths, and that multiplex the optical add traffic (if it is in multiple wavelengths). Add coupler 140 combines this received add traffic with the copy of the input traffic received from drop coupler 130b and forwards this combined traffic to WSS 170. WSS 170 receives this combined traffic and forwards the combined traffic to its output port for communication from access node 312. As noted above, WSS 170 also receives a copy of the input traffic from coupler 130a; however, WSS 170 terminates this traffic since it also receives this traffic from add coupler 140 (which receives it from drop coupler 130b). In this manner, traffic may be dropped, passed through, and added by node 312.

FIGS. 7A and 7B are block diagrams illustrating particular embodiments of interconnection nodes that may be used in association with particular embodiments of the present invention. As indicated in FIGS. 1-5, interconnection nodes may serve as the entry point to and/or the exit point from a Level 2 network 30. In the description below associated with FIGS. 7A and 7B, it is assumed that the illustrated interconnection nodes serve as both an entry point and an exit point.

FIG. 7A is a block diagram illustrating details of an interconnection node 414 in accordance with one embodiment of the present invention. This particular embodiment may be used in association with the use of sub-wavelengths, for example, as described in FIG. 4A. Interconnection node 414 comprises an amplifier 420, a drop coupler 430, and a WSS 440. These components are positioned “in-line” on a fiber of the Level 1 network 20. Although not illustrated, node 414 may include components appropriate to facilitate communication of traffic to and from client devices of interconnection node 414 (in addition to communicating traffic to and from an associated Level 2 network 30). Furthermore, although interconnection node 414 as illustrated includes only components associated with a single fiber, particular embodiments of interconnection node 414 may be configured to receive and transmit traffic on Level 1 network 20 in more than one direction and may include additional components to facilitate such operation. For example, in a particular embodiment of network 10, traffic may propagate around Level 1 network 20 in two directions with traffic on a first fiber traveling in a clockwise direction and traffic on a second fiber traveling in a counterclockwise direction. In such an embodiment, interconnection node 14 may include two of each of amplifier 420, drop coupler 430, and WSS 440, one of each being coupled to the first fiber for receiving and transmitting clockwise traffic and one of each being coupled to the second fiber for receiving and transmitting counterclockwise traffic.

In the illustrated embodiment, input traffic is received at node 414 and is amplified by amplifier 420. The amplified signal is then forwarded to drop coupler 430, which splits the signal from amplifier 420 into two generally identical signals: a through signal that is forwarded to WSS 440 and a drop signal that is forwarded to the associated Level 2 network 30. The use of drop coupler 430 allows traffic to be broadcast from the Level 1 network 20 to Level 2 networks 30. Although not illustrated, node 414 may also include a wavelength blocker or other suitable component(s) to selectively terminate traffic in one or more wavelengths of the drop signal (to prevent those wavelengths from being broadcast to the associated Level 2 network 30). Alternatively, as described above in conjunction with FIG. 6B, one or more access nodes 12 in a Level 2 network 30 may include such wavelength blockers to prevent circulation of traffic in particular wavelengths.

The through signal is forwarded to WSS 440, which combines the traffic in this through signal with add traffic received from the associated Level 2 network 30. As is illustrated in FIG. 7A, WSS 440 may receive add traffic in one or more wavelengths. This add traffic may comprise traffic in sub-wavelengths. As is illustrated in this figure and as is described above, multiple sub-wavelengths (such as λ₁₋₁, through λ₁₋ₙ) may be simultaneously received at WSS 440 and recognized as a single wavelength (such as λ₁). Therefore, the traffic in all such associated sub-wavelengths is grouped together by WSS 440 and combined with other add traffic and with the through signal from drop coupler 430. This combined traffic is then forwarded from node 414 on the Level 1 network 20. In addition, to combining add traffic and the through signal, WSS 440 may also be configured to terminate traffic in selected wavelengths received from the associated Level 2 network 30. For example, as illustrated in FIG. 2, node 414 may terminate traffic that has been broadcast on the associated Level 2 network 30 from the Level 1 network 20 to prevent it from re-entering the Level 1 network 20 and causing interference.

FIG. 7B is a block diagram illustrating details of an interconnection node 514 in accordance with another embodiment of the present invention. For example, this particular embodiment may be used in association with the network operation described in FIG. 5. As with interconnection node 414, interconnection node 514 comprises an amplifier 520, a drop coupler 530, and a WSS 540. These components are positioned “in-line” on a fiber of the Level 1 network 20. Although not illustrated, node 514 may include components appropriate to facilitate communication of traffic to and from client devices of interconnection node 514 (in addition to communicating traffic to and from an associated Level 2 network 30). Furthermore, although interconnection node 514 as illustrated includes only components associated with a single fiber, particular embodiments of interconnection node 514 may be configured to receive and transmit traffic on Level 1 network 20 in more than one direction and may include additional components to facilitate such operation.

In the illustrated embodiment, input traffic is received at node 514 and is amplified by amplifier 520. The amplified signal is then forwarded to drop coupler 530, which splits the signal from amplifier 520 into two generally identical signals: a through signal that is forwarded to WSS 540 and a drop signal that is forwarded to the associated Level 2 network 30. The use of drop coupler 530 allows traffic to be broadcast from the Level 1 network 20 to Level 2 networks 30. Although not illustrated, node 514 may also include a wavelength blocker or other suitable component(s) to selectively terminate traffic in one or more wavelengths of the drop signal (to prevent those wavelengths from being broadcast to the associated Level 2 network 30).

The through signal is forwarded to WSS 540, which combines the traffic in this through signal with add traffic received from the associated Level 2 network 30. As is illustrated in FIG. 7B, WSS 440 may receive add traffic in one or more wavelengths. As described in conjunction with FIG. 5, this received add traffic may comprise traffic from the associated Level 2 network 30 that has been combined and placed into a different wavelength. Other add traffic may be received by WSS 540 in the same wavelength that it was added to the associated Level 2 network 30. To facilitate these two different techniques for adding traffic to the Level 1 network 20, node 514 includes one or more filters 542, at least one demultiplexer 544, and at least one wavelength conversion and traffic grooming unit 546. Traffic received from the associated Level 2 network 30 first passes through filter 542 (or any other suitable component) which strips off the traffic in one or more selected wavelengths of the main signal and which forwards the traffic in these stripped wavelengths directly to WSS 540 (in the illustrated example, λ₅). The traffic in the remaining wavelengths is forwarded to demultiplexer 544 which demultiplexes the received signal into its constituent wavelengths (in the illustrated example, λ₁, λ₂ and λ₃). The traffic in each of these demultiplexed wavelengths is then forwarded to unit 546, which represents any suitable components that receive the optical traffic in the demultiplexed wavelengths, convert the optical traffic to electrical traffic, combine the electrical traffic, and then generate an optical signal including the combined traffic at a wavelength different than the wavelengths received by demultiplexer 544 (in the illustrated example, λ₁₀). For example, unit 546 may include optical receivers to convert the received optical signals into electrical signals, a switch or other suitable component operable combine the electrical traffic, and at least one optical transmitter operable to transmit the combined traffic as an optical signal. The add traffic received at WSS 540 (either from a unit 546 or from a filter 542) is combined with the through signal from drop coupler 530 and is forwarded on the Level 1 network 20.

In addition to combining add traffic and the through signal, WSS 540 may also be configured to terminate traffic in selected wavelengths received from the associated Level 2 network 30. For example, as illustrated in FIG. 2, node 414 may terminate traffic that has been broadcast on the associated Level 2 network 30 from the Level 1 network 20 to prevent it from re-entering the Level 1 network 20 and causing interference.

Although the present invention has been described with several embodiments, various changes and modifications may be suggested to one skilled in the art. It is intended that the present invention encompass such changes and modifications as fall within the scope of the appended claims.

What is claimed is:

1. An optical network, comprising:
at least one Level 1 network comprising a plurality of interconnection nodes and operable to communicate optical signals to and from the interconnection nodes, the optical signals comprising multiple wavelengths, each wavelength operable to carry traffic;
one or more Level 2 networks each comprising one or more access nodes and operable to communicate optical signals to and from the access nodes, the one or more Level 2 networks coupled to the Level 1 network via at least one interconnection node;
one or more of the access nodes each operable to add upstream traffic to the associated Level 2 network in a sub-wavelength, each sub-wavelength comprising a portion of a passband of one of the wavelengths associated with the Level 1 network; and
one or more of the interconnection nodes each operable to:
receive upstream traffic from a plurality of access nodes in a plurality of sub-wavelengths;
process the upstream traffic in the plurality of sub-wavelengths as traffic in a single wavelength associated with the Level 1 network; and
forward the upstream traffic from the plurality of access nodes in the single wavelength on the Level 1 network.

2. The optical network of claim 1, wherein one or more of the interconnection nodes comprise a wavelength selective switch operable to receive, process, and forward the traffic in the plurality of sub-wavelengths.

3. The optical network of claim 1, wherein one or more of the access nodes comprise:
a drop coupler operable to receive traffic on the associated Level 2 network, to forward a copy of the traffic, and to drop a copy of the traffic; and
an add coupler operable to receive the forwarded copy of the traffic from the drop coupler, to receive upstream traffic to be added to the Level 2 network from one or more clients of the access node, and to combine the forwarded copy and the upstream traffic for communication on the Level 2 network.

4. The optical network of claim 1, wherein one or more of the interconnection nodes are further operable to:
receive broadcast traffic on the Level 1 network, the broadcast traffic transmitted in one or more wavelengths of the optical signals transmitted on the Level 1 network;
forward a first copy of the broadcast traffic on the Level 1 network; and
forward a second copy of the broadcast traffic to an associated Level 2 network.

5. The optical network of claim 4, wherein one or more of the interconnection nodes comprise a drop coupler coupled to the Level 1 network and operable to:
split an optical signal received on the Level 1 network comprising the broadcast traffic into a first copy of the optical signal and a second copy of the optical signal;
forward the first copy of the optical signal on the Level 1 network; and
forward the second copy of the optical signal to the associated Level 2 network.

6. A method for providing optical communication, comprising:
communicating optical signals to and from a plurality of interconnection nodes coupled to at least one Level 1 network, the optical signals comprising multiple wavelengths, each wavelength operable to carry traffic;
communicating optical signals to and from one or more access nodes coupled to one or more Level 2 networks, the one or more Level 2 networks coupled to the Level 1 network via at least one interconnection node;
adding upstream traffic to the associated Level 2 network from each of a plurality of the access nodes in a sub-wavelength, each sub-wavelength comprising a portion of a passband of one of the wavelengths associated with the Level 1 network; and
at an interconnection node:
receiving upstream traffic from the plurality of access nodes in a plurality of sub-wavelengths;
processing the upstream traffic in the plurality of sub-wavelengths as traffic in a single wavelength associated with the Level 1 network; and
forwarding the upstream traffic from the plurality of access nodes in the single wavelength on the Level 1 network.

7. The method of claim 6, wherein one or more of the interconnection nodes comprise a wavelength selective switch operable to receive, process, and forward the traffic in the plurality of sub-wavelengths.

8. The method of claim 6, wherein one or more of the access nodes comprise:
a drop coupler operable to receive traffic on the associated Level 2 network, to forward a copy of the traffic, and to drop a copy of the traffic; and
an add coupler operable to receive the forwarded copy of the traffic from the drop coupler, to receive upstream traffic to be added to the Level 2 network from one or more clients of the access node, and to combine the forwarded copy and the upstream traffic for communication on the Level 2 network.

9. The method of claim 6, further comprising, at one or more of the interconnection nodes:
receiving broadcast traffic on the Level 1 network, the broadcast traffic transmitted in one or more wavelengths of the optical signals transmitted on the Level 1 network;
forwarding a first copy of the broadcast traffic on the Level 1 network; and
forwarding a second copy of the broadcast traffic to an associated Level 2 network.

10. The method of claim 9, wherein one or more of the interconnection nodes comprise a drop coupler coupled to the Level 1 network and operable to:
split an optical signal received on the Level 1 network comprising the broadcast traffic into a first copy of the optical signal and a second copy of the optical signal;
forward the first copy of the optical signal on the Level 1 network; and
forward the second copy of the optical signal to the associated Level 2 network.

11. An optical network, comprising:
at least one Level 1 network comprising a plurality of interconnection nodes and operable to communicate optical signals to and from the interconnection nodes, the optical signals comprising multiple wavelengths, each wavelength operable to carry traffic;
one or more Level 2 networks each comprising one or more access nodes and operable to communicate optical signals to and from the access nodes, the one or more Level 2 networks coupled to the Level 1 network via at least one interconnection node;
one or more of the access nodes each operable to add upstream traffic to the associated Level 2 network in a particular wavelength, wherein access nodes associated with the same Level 2 network use different wavelengths to add upstream traffic and wherein access nodes associated with different Level 2 networks may use the same wavelength to add upstream traffic; and
one or more of the interconnection nodes each operable to:
receive upstream traffic from a plurality of access nodes in a plurality of wavelengths;
combine the received upstream traffic; and
forward the upstream traffic on the Level 1 network in a wavelength different than the plurality of wavelengths in which the upstream traffic was received by the interconnection node.

12. The optical network of claim 11, wherein one or more of the interconnection nodes comprise:
a demultiplexer operable to receive an input optical signal comprising the upstream traffic from the plurality of access nodes in the plurality of wavelengths and to demultiplex the input optical signal into its constituent wavelengths;
a plurality of optical receivers operable to convert the received upstream traffic in the plurality of wavelengths into electrical traffic;
a switch operable to combine the electrical traffic from the plurality of access nodes; and
at least one transmitter operable to generate an output optical signal from the combined electrical traffic.

13. The optical network of claim 12, wherein one or more of the interconnection nodes further comprise a wavelength selective switch operable to receive the output optical signal from the transmitter and to add the output optical signal to the Level 1 network.

14. The optical network of claim 13, wherein one or more of the interconnection nodes further comprise one or more filters operable to:
separate upstream traffic in one or more wavelengths from the upstream traffic in one or more other wavelengths before the upstream traffic reaches the demultiplexer; and
communicate the separated upstream traffic directly to the wavelength selective switch.

15. The optical network of claim 11, wherein one or more of the access nodes comprise:
a drop coupler operable to receive traffic on the associated Level 2 network, to forward a copy of the traffic, and to drop a copy of the traffic; and
an add coupler operable to receive the forwarded copy of the traffic from the drop coupler, to receive upstream traffic to be added to the Level 2 network from one or more clients of the access node, and to combine the forwarded copy and the upstream traffic for communication on the Level 2 network.

16. The optical network of claim 11, wherein one or more of the interconnection nodes are further operable to:
receive broadcast traffic on the Level 1 network, the broadcast traffic transmitted in one or more wavelengths of the optical signals transmitted on the Level 1 network;
forward a first copy of the broadcast traffic on the Level 1 network; and
forward a second copy of the broadcast traffic to an associated Level 2 network.

17. The optical network of claim 16, wherein one or more of the interconnection nodes comprise a drop coupler coupled to the Level 1 network and operable to:
split an optical signal received on the Level 1 network comprising the broadcast traffic into a first copy of the optical signal and a second copy of the optical signal;
forward the first copy of the optical signal on the Level 1 network; and
forward the second copy of the optical signal to the associated Level 2 network.

18. A method for providing optical communication, comprising:
communicating optical signals to and from a plurality of interconnection nodes coupled to at least one Level 1 network, the optical signals comprising multiple wavelengths, each wavelength operable to carry traffic;
communicating optical signals to and from one or more access nodes coupled to one or more Level 2 networks, the one or more Level 2 networks coupled to the Level 1 network via at least one interconnection node;
adding upstream traffic to the associated Level 2 network from each of a plurality of the access nodes in a particular wavelength, wherein access nodes associated with the same Level 2 network use different wavelengths to add upstream traffic and wherein access nodes associated with different Level 2 networks may use the same wavelength to add upstream traffic; and
at an interconnection node:
receiving upstream traffic from a plurality of access nodes in a plurality of wavelengths;
combining the received upstream traffic; and
forwarding the upstream traffic on the Level 1 network in a wavelength different than the plurality of wavelengths in which the upstream traffic was received by the interconnection node.

19. The method of claim 18, further comprising, at the interconnection node:
receiving an input optical signal comprising the upstream traffic from the plurality of access nodes in the plurality of wavelengths;
demultiplexing the input optical signal into its constituent wavelengths;
converting the received upstream traffic in the plurality of wavelengths into electrical traffic;
combining the electrical traffic from the plurality of access nodes; and
generate an output optical signal from the combined electrical traffic.

20. The method of claim 19, wherein the interconnection node further comprises a wavelength selective switch operable to receive the output optical signal from the transmitter and to add the output optical signal to the Level 1 network.

21. The method of claim 20, further comprising, at the interconnection node:
separating upstream traffic in one or more wavelengths from the upstream traffic in one or more other wavelengths before the upstream traffic is demultiplexed; and
communicating the separated upstream traffic directly to the wavelength selective switch.

22. The method of claim 18, wherein one or more of the access nodes comprise:
a drop coupler operable to receive traffic on the associated Level 2 network, to forward a copy of the traffic, and to drop a copy of the traffic; and
an add coupler operable to receive the forwarded copy of the traffic from the drop coupler, to receive upstream traffic to be added to the Level 2 network from one or more clients of the access node, and to combine the forwarded copy and the upstream traffic for communication on the Level 2 network.

23. The method of claim 18, further comprising, at one or more of the interconnection nodes:
receiving broadcast traffic on the Level 1 network, the broadcast traffic transmitted in one or more wavelengths of the optical signals transmitted on the Level 1 network;
forwarding a first copy of the broadcast traffic on the Level 1 network; and
forwarding a second copy of the broadcast traffic to an associated Level 2 network.

24. The method of claim 23, wherein one or more of the interconnection nodes comprise a drop coupler coupled to the Level 1 network and operable to:
split an optical signal received on the Level 1 network comprising the broadcast traffic into a first copy of the optical signal and a second copy of the optical signal;
forward the first copy of the optical signal on the Level 1 network; and
forward the second copy of the optical signal to the associated Level 2 network.
